(19) United States
(12) Patent Application Publication
(10) Pub. No.: US 2017/0032420 A1
(43) Pub. Date: Feb. 2, 2017

(54) PUBLISHER FACILITATED ADVERTISEMENT MEDIATION

(71) Applicant: Linkedln Corporation, Mountain View, CA (US)

(72) Inventors: Divye Raj Khilnani, Sunnyvale, CA (US); Yawen Wei, Sunnyvale, CA (US); Anand Rajgopal Mundada, Sunnyvale, CA (US); Kaiyang Liu, Saratoga, CA (US)

(21) Appl. No.: 14/813,012

(22) Filed: Jul. 29, 2015

(51) Int. Cl. G06Q 30/02; G06Q 50/00

(52) U.S. Cl. CPC G06Q 30/0261; G06Q 30/0273; G06Q 30/0275; G06Q 50/01

(57) ABSTRACT

A system and method for publisher facilitated advertisement mediation are provided. In example embodiments, a request to provide advertisement content is received from a user device. The request includes context data indicating a context of the request. In response to the request, a specification of an advertisement is assembled. A price for placing the advertisement is calculated based on the context data. The specification of the advertisement and the price are transmitted to the user device.

### BACKGROUND

Advertising networks operate by providing advertisements received from paying advertisers to content providers such as websites, mobile applications, and other mediums. In a typical scenario, content providers include embedded code into content distributed to end users and the embedded code, when executed, requests an advertisement from the advertising network. The advertising network responds with a particular advertisement from a particular advertiser unless there are no advertisements available. That is to say, the advertisement request is fulfilled or filled by the advertising network. When no advertisement is returned by the advertising network, the embedded code may request an advertisement from another advertising network to prevent a missed opportunity to present an advertisement and mitigate lost revenue from vacant advertisement space. However, such an approach does not guarantee optimal or maximal revenue from an advertisement space as it merely attempts to ensure that the advertisement space is not unfilled.

### BRIEF DESCRIPTION OF THE DRAWINGS

Various ones of the appended drawings merely illustrate example embodiments of the present disclosure and cannot be considered as limiting its scope.

FIG. 1 is a network diagram depicting a client-server system within which various example embodiments may be deployed.

FIG. 2 is a block diagram illustrating an example embodiment of a mediation system, according to some example embodiments.

FIG. 3 is a block diagram illustrating various example communications between devices and systems during functioning of an advertising network, according to some example embodiments.

FIG. 4 is a flow diagram illustrating an example method for providing a price for placing an advertisement, according to some example embodiments.

FIG. 5 is a flow diagram illustrating further example operations for assembling a specification of an advertisement, according to some example embodiments.

FIG. 6 is a flow diagram illustrating further example operations for calculating a price for placing an advertisement, according to some example embodiments.

FIG. 7 is a flow diagram illustrating further example operations for calculating a price for placing an advertisement using member data of a social network service, according to some example embodiments.

FIGS. 8A and 8B are swim-lane diagrams illustrating various communications between devices performing a method for publisher facilitated advertisement mediation, according to some example embodiments.

FIGS. 9 and 10 illustrate example user interfaces that include advertisements, according to some example embodiments.

FIG. 11 is a block diagram illustrating an example of a software architecture that may be installed on a machine, according to some example embodiments.

FIG. 12 illustrates a diagrammatic representation of a machine in the form of a computer system within which a set of instructions may be executed for causing the machine to perform any one or more of the methodologies discussed herein, according to an example embodiment.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

In various example embodiments, an advertising network system receives a request, from a user device, for an advertisement (also referred to herein as an “ad”). For example, a content provider or publisher has embedded code within publisher content that has been distributed to the user device (e.g., a mobile application downloaded by the user device). The embedded code triggers a request for the advertisement (e.g., when a publisher provided mobile app or website opens, a refresh time trigger, or another type of request trigger). In some embodiments, the request for the advertisement includes context data that indicates a context of the request for the advertisement. For example, the context data includes data associated with the request such a device type for the user device, a software type (e.g., a particular app of the user device that initiated the request), a geolocation of the user device, a device identifier, a user identifier, sensor data detected by the user device (e.g., ambient lighting or sound conditions), or other contextual data associated with the request.

In response to the request for the advertisement, the advertising network system assembles a specification of a particular advertisement to return to the user device. For example, the specification of the particular advertisement includes a title text, a description text, a background image, or other advertisement data. In an embodiment, an advertiser (e.g., an entity such as a business that wishes to promote a product using the advertising network system) previously provided the advertisement data to the advertising network system. In these embodiments, the embedded code on the user device generates the advertisement at the user device using the specification of the advertisement. This type of scheme is referred to herein as a “native advertisement.” Native advertisements can be customized to adapt to a particular scheme (e.g., color scheme or design theme) at the user device or client side. In other embodiments, the specification of the particular advertisement includes the advertisement itself (e.g., a banner ad image) that is not necessarily customizable at the user device.

In an embodiment, the advertising network system calculates a placement price for placing the advertisement on a user interface of the user device. The placement price is an amount paid to the publisher for showing the advertisement to a user. For instance, the advertiser provides a bid price when the advertiser submits the advertisement to the advertising network system (e.g., the advertiser is willing to pay $1.00 per interaction such as a person clicking on the advertisement on the advertisement or $0.05 per impression such as a person viewing the advertisement). In an embodiment, the advertising network system uses the bid price in combination with a number of other factors to determine the placement price. For instance, the advertising network system calculates an interaction likelihood that the user of the user device requesting the advertisement will be interested in the advertisement and interact with the advertisement. Subsequently, the advertising network system calculates the placement price based on the interaction likelihood.

After the advertising network system assembles the specification of the advertisement and calculates the placement price, the advertising network system transmits, communicates, or otherwise provides the specification of the advertisement and the placement price to the user device. The embedded code of the publisher at the user device may then generate the advertisement and determine whether to show or where to the place the advertisement based on the placement price. For example, the embedded code may determine that the placement price is lower than a placement price for a different advertising network and, based on that determination, present a higher paying advertisement from the different advertisement network. In this way, the advertising network system allows the publisher to mediate advertisements. This provides transparency to allow for an efficient market for advertisements and provides the publisher an opportunity to optimize or maximize revenue for their content.

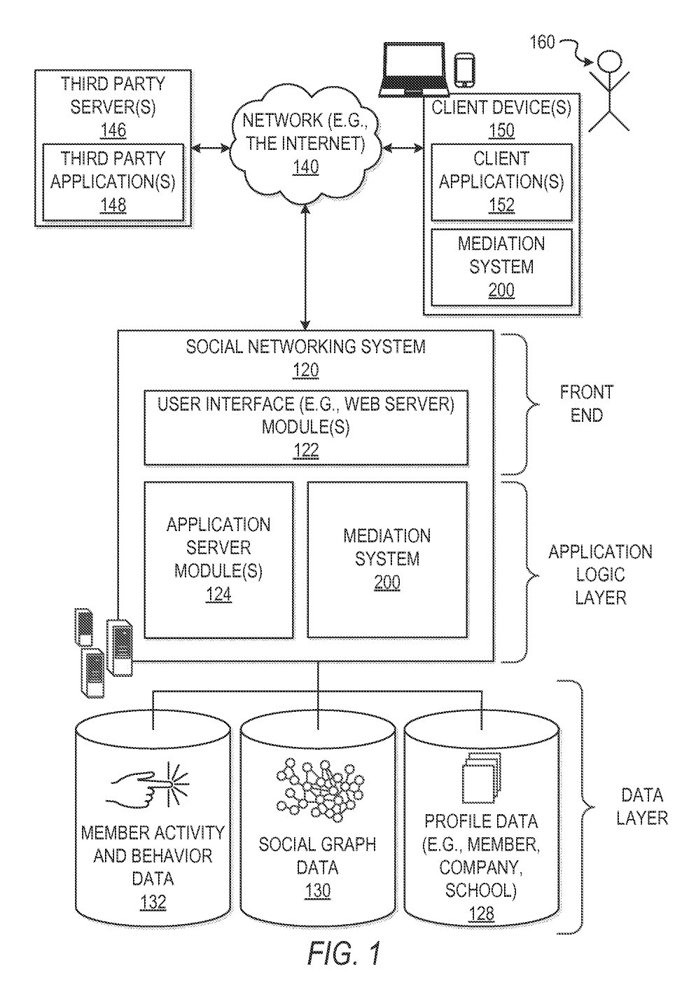

As shown in FIG. 1, the social networking system 120 is generally based on a three-tiered architecture, consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 1. However, a skilled artisan will readily recognize that various additional functional modules and engines may be used with a social networking system, such as that illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although depicted in FIG. 1 as a three-tiered architecture, the inventive subject matter is by no means limited to such an architecture.

As shown in FIG. 1, the front end layer consists of a user interface module(s) (e.g., a web server) 122, which receives requests from various client-computing devices including one or more client device(s) 150, and communicates appropriate responses to the requesting device. For example, the user interface module(s) 122 may receive requests in the form of Hypertext Transport Protocol (HTTP) requests, or other web-based. Application Programming Interface (API) requests. The client device(s) 150 may be executing conventional web browser applications and/or applications (also referred to as “apps”) that have been developed for a specific platform to include any of a wide variety of mobile computing devices and mobile-specific operating systems (e.g., iOS™, Android™, Windows@ Phone). For example, client device(s) 150 may be executing client application(s) 152. The client application(s) 152 may provide functionality to present information to the user and communicate via the network 140 to exchange information with the social networking system 120. Each of the client devices 150 may comprise a computing device that includes at least a display and communication capabilities with the network 140 to access the social networking system 120. The client devices 150 may comprise, but are not limited to, remote devices, work stations, computers, general purpose computers, Internet appliances, hand-held devices, wireless devices, portable devices, wearable computers, cellular or mobile phones, personal digital assistants (PDAs), smart phones, tablets, ultrabooks, netbooks, laptops, desktops, multi-processor systems, microprocessor-based or programmable consumer electronics, game consoles, set-top boxes, network PCs, mini-computers, and the like. One or more users 160 may be a person, a machine, or other means of interacting with the client device(s) 150. The user(s) 160 may interact with the social networking system 120 via the client device(s) 150. The user(s) 160 may not be part of the networked environment, but may be associated with client device(s) 150.

As shown in FIG. 1, the data layer includes several databases, including a database 128 for storing data for various entities of the social graph, including member profiles, company profiles, educational institution profiles, as well as information concerning various online or offline groups. Of course, with various alternative embodiments, any number of other entities might be included in the social graph and, as such, various other databases may be used to store data corresponding with other entities.

Consistent with some embodiments, when a person initially registers to become a member of the social networking service, the person will be prompted to provide some personal information, such as his or her name, age (e.g., birth date), gender, interests, contact information, home town, address, the names of the member's spouse and/or family members, educational background (e.g., schools, majors, etc.), current job title, job description, industry, employment history, skills, professional organizations, interests, and so on. This information is stored, for example, as profile data in the database 128.

Once registered, a member may invite other members, or be invited by other members, to connect via the social networking service. A “connection” may specify a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not necessarily require acknowledgement or approval by the member that is being followed. When one member connects with or follows another member, the member who is connected to or following the other member may receive messages or updates (e.g., content items) in his or her personalized content stream about various activities undertaken by the other member. More specifically, the messages or updates presented in the content stream may be authored and/or published or shared by the other member, or may be automatically generated based on some activity or event involving the other member. In addition to following another member, a member may elect to follow a company, a topic, a conversation, a web page, or some other entity or object, which may or may not be included in the social graph maintained by the social networking system 120. With some embodiments, because the content selection algorithm selects content relating to or associated with the particular entities that a member is connected with or is following, as a member connects with and/or follows other entities, the universe of available content items for presentation to the member in his or her content stream increases.

As members interact with various applications, content, and user interfaces of the social networking system 120, information relating to the member's activity and behavior may be stored in a database, such as the database 132.

The social networking system 120 may provide a broad range of other applications and services that allow members the opportunity to share and receive information, often customized to the interests of the member. For example, with some embodiments, the social networking system 120 may include a photo sharing application that allows members to upload and share photos with other members. With some embodiments, members of the social networking system 120 may be able to self-organize into groups, or interest groups, organized around a subject matter or topic of interest. With some embodiments, members may subscribe to or join groups affiliated with one or more companies. For instance, with some embodiments, members of the social network service may indicate an affiliation with a company at which they are employed, such that news and events pertaining to the company are automatically communicated to the members in their personalized activity or content streams. With some embodiments, members may be allowed to subscribe to receive information concerning companies other than the company with which they are employed. Membership in a group, a subscription or following relationship with a company or group, as well as an employment relationship with a company, are all examples of different types of relationships that may exist between different entities, as defined by the social graph and modeled with social graph data of the database 130.

The application logic layer includes various application server module(s) 124, which, in conjunction with the user interface module(s) 122, generates various user interfaces with data retrieved from various data sources or data services in the data layer. With some embodiments, individual application server modules 124 are used to implement the functionality associated with various applications, services and features of the social networking system 120. For instance, a messaging application, such as an email application, an instant messaging application, or some hybrid or variation of the two, may be implemented with one or more application server modules 124. A photo sharing application may be implemented with one or more application server modules 124. Similarly, a search engine enabling users 160 to search for and browse member profiles may be implemented with one or more application server modules 124. Of course, other applications and services may be separately embodied in their own application server modules 124. As illustrated in FIG. 1, social networking system 120 may include a mediation system 200, which is described in more detail below.

Additionally, third party application(s) 148, executing on a third party server(s) 146, are shown as being communicatively coupled to the social networking system 120 and the client device(s) 150. The third party server(s) 146 may support one or more features or functions on a website hosted by the third party.

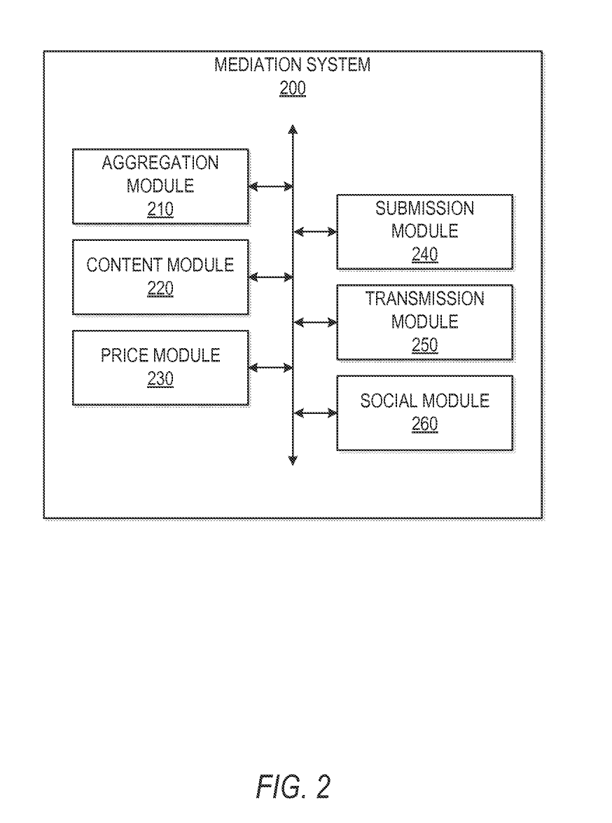

FIG. 2 is a block diagram of the mediation system 200 that provides functionality to assist publishers in selecting an advertisement to display to a user of publisher content, according to some example embodiments. In an example embodiment, the mediation system 200 includes an aggregation module 210, a content module 220, a price module 230, a submission module 240, a transmission module 250, and a social module 260. All, or some, of the modules 210-260 of FIG. 2, communicate with each other, for example, via a network coupling, shared memory, and the like. It will be appreciated that each module can be implemented as a single module, combined into other modules, or further subdivided into multiple modules. Other modules not pertinent to example embodiments can also be included, but are not shown.

The aggregation module 210 provides functionality to receive an advertisement request from one or more user devices. For instance, a user device viewing, running, or otherwise using a particular piece of publisher content triggers a request for an advertisement received at the aggregation module 210. The aggregation module 210 is operable to receive advertisement requests from a plurality of user devices of different users using a variety of publisher content. In some embodiments, the advertisement request includes context data (e.g., geolocation data as determined by a GPS component of the user device) from the user device. The context data indicates a context of the advertisement request such as a device identifier, a user identifier, a particular operating system (OS) from which the advertisement request originated, browser type, current geolocation of the user device, sensor data detected at the user device (e.g., audio level measurements, ambient temperature measurements, or ambient light measurements), and so on.

The content module 220 provides functionality to identify, generate, extract, or assemble various advertisement data used to create an advertisement. For example, the content module 220 may receive, from a device of an advertiser (e.g., a company, individual, or another entity that desires to promote a product or service), an advertisement or a specification of an advertisement. Data associated with the advertisement includes, for example, title text, description text, a background image, a minimum bid amount, a maximum bid amount, and so on. The content module 220 assembles the advertisement data, advertisement metadata, or a specification of the advertisement from data received from the advertiser.

The price module 230, consistent with various embodiments, calculates a placement price for placing the advertisement on a user interface of the user device. In various embodiments, the price module 230 calculates the placement price based on the context data. For example, the price module 230 maps a device identifier included in the context data to a member identifier of a social networking service and determines the placement price based on member data corresponding to the member identifier.

In an example embodiment, the price module 230 calculates the placement price based on a likelihood, or probability, that a member of the social networking service corresponding to the member identifier will interact with (e.g., click or tap the advertisement or a vocal command indicating interest in the advertisement received at a microphone sensor of a smart watch) or be interested in the advertisement. For example, the price module 230 extracts member characteristics from the member data and matches the extracted member characteristics to advertisement characteristics of the advertisement (e.g., the advertisement pertains to sporting equipment and a particular member characteristic indicates the member played a sport in the past, works for a company associated with sporting, or has a social network relationship on the social networking service to a threshold number of members that respectively have a member characteristic similar or matching the advertisement characteristic). In these embodiments, a high number of member characteristics that match, or are similar to, advertisement characteristics corresponds to a high likelihood of the member interacting with or being interested in the advertisement.

In another example embodiment, the price module 230 determines the likelihood that the user may interact with or be interest in the advertisement based on an analysis of historical interactions of the advertisement. For example, the price module 230 may compare the member data of the member corresponding to the member identifier with member data from members that previously interacted with the advertisement. In this example, if the price module 230 determines the member is similar to other members that previously interacted with the advertisement, the price module 230 determines a high likelihood that the member may interact with the advertisement. The price module 230 may determines a similarity between the member and other member based on matching, or nearly matching, member characteristic extracted from the member data of the member and the other members (e.g., comparing work history, current job title, gender, marital status, socioeconomic background, a number of social connections on the social networking service, similar types of social connections on the social networking service, and so on).

In still further embodiments, the price module 230 employs various machine learning techniques to determine the placement price for a particular advertisement. For instance, historical data for interactions with a particular advertisement and member data associated with member that interacted with a particular advertisement can be used in conjunction with machine learning by the price module 230 to determine the placement price.

The submission module 240 provides functionality to receive data associated with advertisement content or marketing content from devices of advertisers. For example, a particular advertiser provides advertisement content such as advertisement data to the submission module 240. The advertisement data includes, for example, the advertisement itself (e.g., a banner image that promotes a product or service), title text, description text, a specification of an action upon activation of the advertisement (e.g., a particular web address to load, a particular social network handle to interact with such as friending, liking, or messaging, or another advertiser specified action), advertisement images (e.g., an image of a product), a minimum bid price, a maximum bid price, or other data associated with the advertisement. The submission module 240 can provide a user interface configured to receive advertisements from advertisers.

The transmission module 250 provides functionality to communicate, transmit, or otherwise provide the advisement data and the placement price to a user device that requested an advertisement. For instance, the transmission module 250 sends a network transmission that includes the advertisement data and the placement price to the user device.

The social module 260 provides various social media functionality. For example, the social module 260 maps an advertisement identifier received with the advertisement request to a member identifier of a social network service. The social module 260 can also access member data corresponding to the member identifier to be used when calculating the placement price. In some embodiments, a portion of the member data is provided to the user device to further assist the publisher in determining whether to present or show the advertisement.

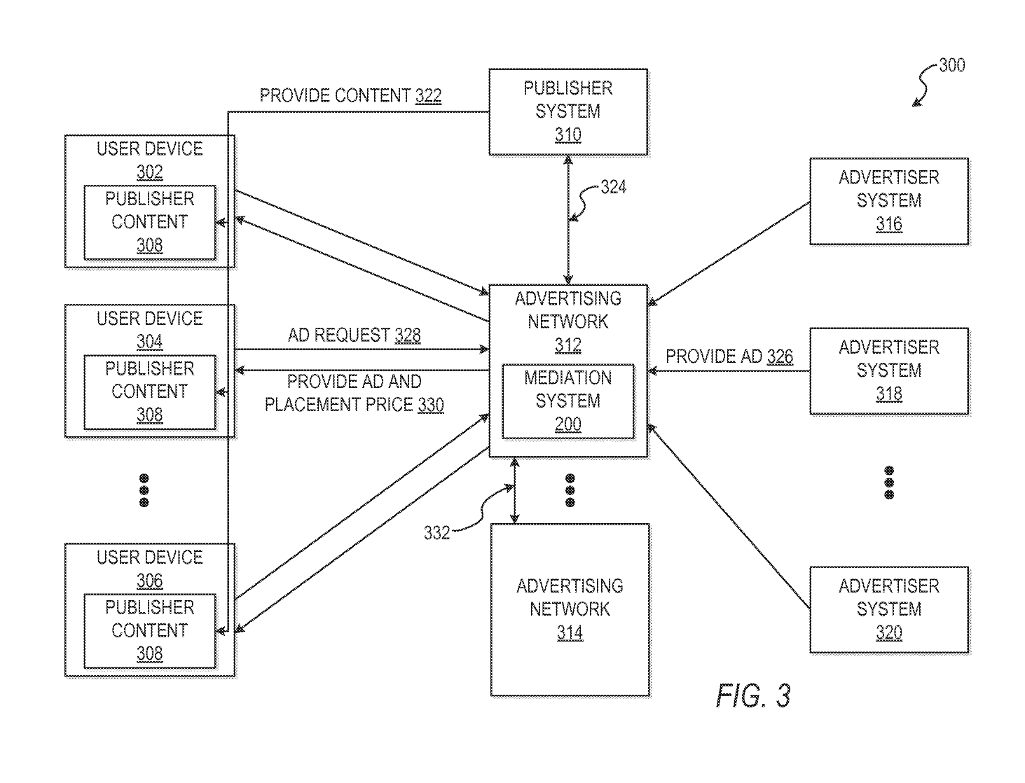

FIG. 3 is a block diagram 300 illustrating various example communications between devices and systems during functioning of an advertising network. In the block diagram 300, user devices 302, 304, and 306 are shown to include publisher content 308. In an embodiment, the publisher content 308 is provided by the publisher system 310 as shown by communication 322. For instance, the user devices 302, 304, and 306 may have downloaded the publisher content 308 from the publisher system 310 or from another third-party system (e.g., an app store such as the GOOGLE PLAY®).

Advertising network 312 includes the mediation system 200. In some embodiments, the advertising network 312 is part of the social networking system 120 or a portion of the advertising network 312 is implemented on the social networking system 120. In other example embodiments, the advertising network 312 is independent of the social networking system 120 but is communicatively coupled to the social networking system 120. The block diagram 300 also includes other advertising networks such as advertising network 314. Advertiser system 316, 318, and 320 are devices of the advertisers that provide advertising content to the advertising network 312. For instance, an advertiser, such as a business, an individual, or another entity, submits advertisement data, as shown by communication 326, to the advertising network 312 to promote a particular product or service.

In a specific example, the user device 304 includes publisher content 308 which triggers a request for an advertisement as shown by communication 328. The advertisement request 328 may include context data associated with the advertisement request 328 such as a type of operating system the user device 304 is using. Upon the mediation system 200 receiving the advertisement request, the mediation system 200 identifies an advertisement previously submitted by an advertiser. For example, the mediation system 200 identifies an advertisement that is compatible with the particular operating system specified in the context data. In other examples, the mediation system 200 maps an advertisement identifier included in the context to a member identifier of a social network service. The mediation system 200 may then access member data corresponding to the member identifier and identify or select an advertisement based on the member data (e.g., an advertisement that a member for the member identifier may be more likely to interact with). The mediation system 200 calculates a placement price for the advertisement. For example, the mediation system 200 calculates an interaction likelihood value for the advertisement and for the member of the member identifier. The interaction likelihood value indicates a probability that the member will interact with (e.g., click on) the advertisement. The mediation system 200 then calculates the placement price based on the interaction likelihood (e.g., a higher price for a high probability of interaction with the advertisement). The mediation system 200 communicates, transmits, or otherwise provides the identified advertisement and the placement price to the user device 304. The user device 304 can then present the advertisement or self-mediate by presenting another advertisement that is higher priced (e.g., an advertisement retrieved from another advertising network such as the advertising network 314).

In further embodiments, the mediation system 200 assembles guidance data or advisement data associated with the advertisement. The advisement data can include a portion of the member data or other data gathered by the mediation system 200 in association with the advertisement and the member identifier. The code embedded in the publisher content 308 on the user device 304 can utilize the advisement data in determining whether to present the advertisement. For example, if the advisement data indicates an occupation of the member of the member identifier, the embedded code can self-mediate and determine whether to present the identified advertisement or another advertisement based on the advisement data. In some embodiments, advisement data includes placement prices from other advertising networks, such as the advertising network 314. For example, the mediation system 200 exchanges communications with the advertising network 314, as shown in FIG. 3 by communication 332, to retrieve a competitor's placement price from the advertising network 314. The advisement data can include the competitor's placement price to assist the publisher in determining whether to present the advertisement.

In still further embodiments, the publisher system 310 communicates with mediation system 200 as shown by communication 324 in FIG. 3. For example, the mediation system 200 retrieves publisher-specified criteria or data associated with the advertisement request trigger by coded embedded in the publisher content 308. For example, the mediation system 200 provides the advertisement, the placement price, and the advisement data to the publisher system 310. Centralized logic at the publisher system 310 determines whether to present the advertisement at the user device 304 where the advertisement request originates. In this scheme, the self-mediation of advertisements by the publisher system 310 is centralized, or quasi-centralized, at the publisher system 310 rather than federated across a plurality of user devices 302-306 using the publisher content 308. In some embodiments, a combination of centralized and federated publisher self-mediation can be employed by the publisher to optimize or maximize revenue for their content.

In some example embodiments, functions provided by the publisher content, such as the publisher content 308 of FIG. 3, are provided by modules of the publisher content. For instance, the publisher content includes a publisher communication module to provide various communication functions between the publisher content and the social networking system 120, the mediation system 200, the third party servers 146, the advertising systems 316, 318, and 320, the advertising networks 312 and 314, the publisher system 310, and other device (e.g., the publisher communication module may send various network communications and short range communications (e.g., via BLUETOOTH®) to various device). In another instance, the publisher content includes a publisher sensor module to access, detect, or otherwise obtain sensor data from user devices such as user device 302, 304, and 306. In still another instance, the publisher content includes a user interface module that generates user interfaces to be presented to the user (e.g., create the advertisement from the specification of the advertisement and integrate the created advertisement into a user interface of the user device). The publisher content also includes an advertisement optimization module that selects an advertisement based on, for example, a price received corresponding to the advertisement (e.g., selecting a particular advertisement corresponding to a highest estimated price), content of the advertisement, availability of an advertisement from a particular advertising network, or another condition, criteria, or based on other data. The publisher content may also include a variety of other modules to facilitate the functions described herein associated with the publisher content.

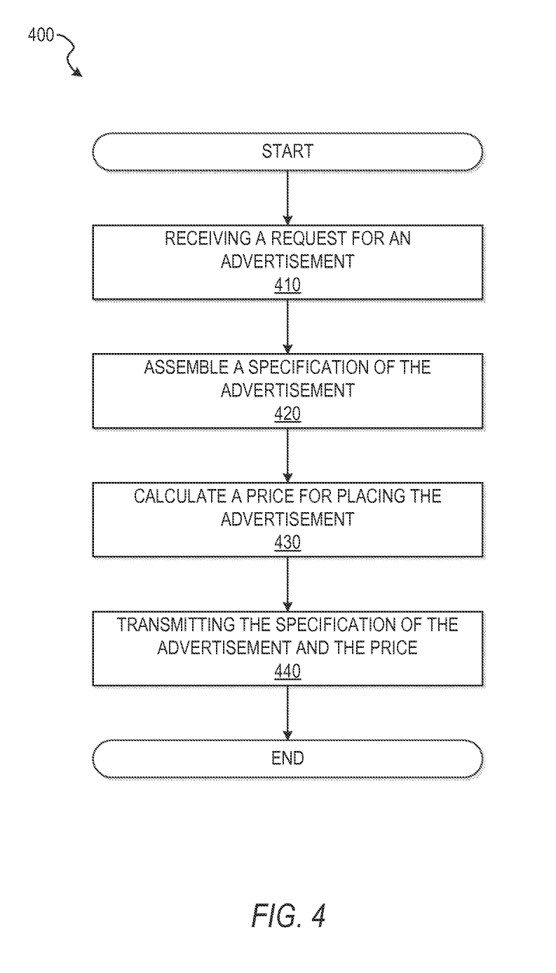

FIG. 4 is a flow diagram illustrating an example method 400 for providing a price for placing an advertisement. The operations of the method 400 may be performed by components of the mediation system 200, and are so described below for the purposes of illustration.

At operation 410, the aggregation module 210 receives, from a user device or user system, an advertisement request for advertisement content. In other words, the aggregation module 210 receives a fill request to fill a vacant advertisement position on a user interface of the user system. Put yet another way, the aggregation module 210 receives a placement request to receive marketing content for an advertisement space on a user interface of the user device.

In various embodiments, the advertisement request includes context data indicating a context of the advertisement request. The context data includes, for example, a device identifier, a user identifier, an advertisement identifier, a device module, a device screen size, a device input/output capability, a particular operating system (OS) from which the advertisement request originated, browser type, geolocation data indication a current geolocation of the user device, sensor data detected at the user device (e.g., audio level measurements, ambient temperature measurements, number of nearby devices, or ambient light measurements), an advertisement space size or location on the user device screen (e.g., banner across top or full screen space), user device activity (e.g., a length of a use session for the user device or an indication of task recently performed on the user device), or other contextual data associated with the advertisement request. For instance, the aggregation module 210 may receive an indication of one or more devices that are within a distance of the user device (e.g., as determined via, for example, BLUETOOTH® broad casts or other short range communication schemes). As discussed more below, the price module 230 factors such context data when calculating a placement price for the advertisement (e.g., inferring multiple user are viewing the device and adjusting the placement price based on a number of estimated viewers).

At operation 420, the content module 220, in response to the advertisement request, assembles a specification of an advertisement, advertisement metadata, or advertisement data. The specification of the advertisement is used to create the advertisement at the user device. In a specific example, the specification of the advertisement includes a title text, description text, an email address, a social network identifier and an associated action (e.g., a particular handle to follow, like, message, etc.), a website address, a particular action to perform (e.g., send a text message to a particular telephone number), a background image, color, texture, or pattern, or a product image. In this example, the user device utilizes these components of the advertisement to create the advertisement at the user device such that the advertisement blends or fits a theme at the user device. That is to say, the specification of the advertisement includes customizable portions of the advertisement customizable at the user device. For instance, code embedded into the publisher content (e.g., the publisher content 308 of FIG. 3) creates an advertisement from the specification of the advertisement with a font and color scheme that matches that of the publisher content. In this way, the advertisement can conform to a particular look of the publisher content without predefining a style scheme.

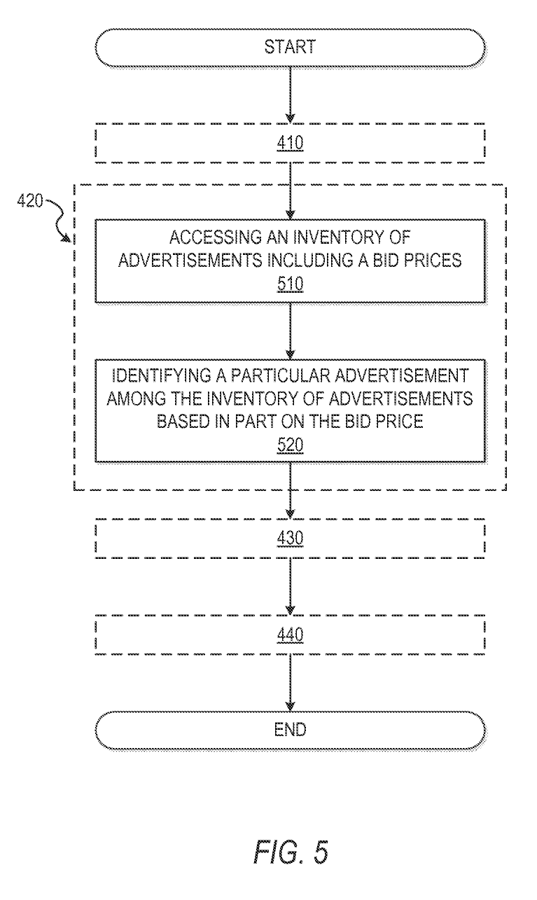

Turning now to FIG. 5, a flow diagram illustrating further example operations for assembling a specification of an advertisement is shown. Subsequent to the aggregation module 210 receiving the advertisement request at operation 410, the content module 220 assembles the specification of the advertisement at operation 420. In some embodiments, operation 420 includes the additional operations of FIG. 5.

At operation 510, the content module 220 accesses an inventory of advertisements including various data such as a bid price. For example, a plurality of advertisers have previously submitted, to the submission module 240, advertisements and associated data such as a bid price that the advertiser is willing to pay for an interaction with the advertisement or a viewing of the advertisement, advertisement description data (e.g., title, product brand name, product price, or product web address), targeting data (e.g., demographic information specified by the publisher indicating an ideal demographic for the advertisement), and other data.

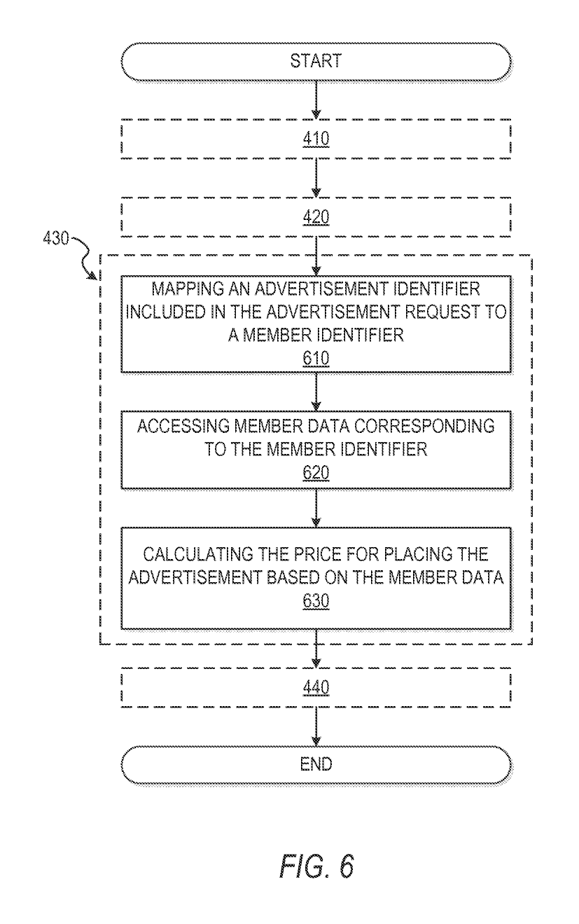

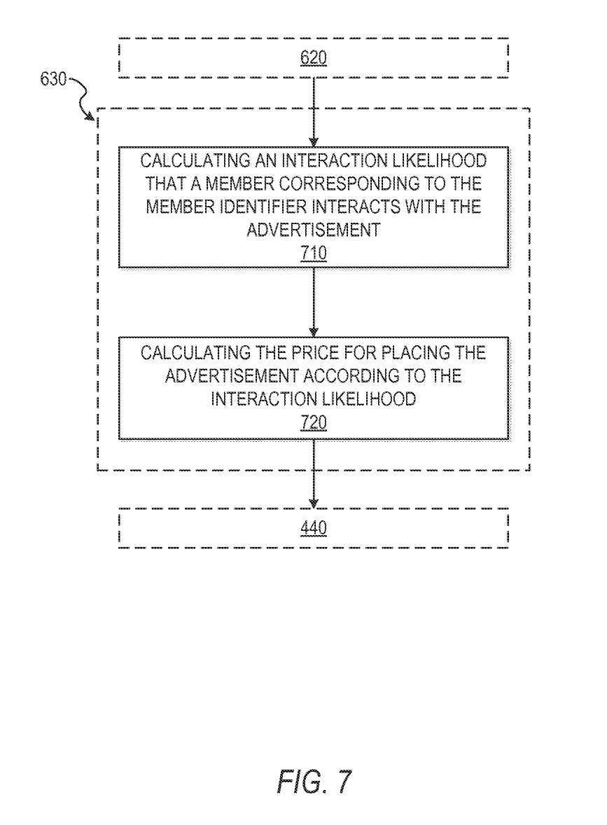

At operation 520, the content module 220 identifies a particular advertisement among the inventory of advertisement to provide in response to the advertisement request. For instance, the content module 220 access a bid price for respective advertisements of the inventory of advertisements where the bid price indicates a price that the advertiser pays for at least one of a user interaction with the advertisement or a user view of the advertisement. In this instance, the content module 220 identifies the particular advertisement according to a highest bid price for the respective advertisements of the inventory of advertisements. In other embodiments, the content module 220 matches target demographic data (e.g., age, gender, marital status, or location) received from the advertiser with demographic data included in the context data or accessed from member data of a social network service (e.g., member data for a member identifier mapped to an advertisement identifier included in the context data as will be discussed below in connection with FIG. 6). In still other embodiments, the content module 220 identifies the particular advertisement from the inventory of advertisements according to an interaction likelihood or interaction probability associated with the advertisement and a user of the user device (discussed further below in connection with FIG. 7). In this way, the mediation system 200 can select, identify, or match an advertisement from the inventory of advertisements to the advertisement request in such a way as to optimize revenue by, for example, providing a higher bid price advertisement that the user of the user device is likely to interact with. In some example embodiments, an advertisement that is interacted with is of higher value than an advertisement that is ignored by the user (e.g., the advertiser may only pay for an interaction and not simply for an impression). Thus, in these embodiments, the publisher can increase revenue by presenting advertisements more likely to be interacted with by the user. In other embodiments, an advertisement that that the user is likely to be interest in may be of higher value than an advertisement that the user is unlikely to be interested in (e.g., the advertisement may pay a premium for impressions of the advertisement to certain high value users). In these embodiments, the publisher can increase revenue for a particular piece of publisher content by presenting advertisements to certain users that are likely to be interest in the content of the advertisement.

Turning back to FIG. 4, at operation 430, the price module 230 calculates a placement price for placing the advertisement on a user interface of the user device based on the context data. The placement price, also referred to as a content specific price, probable price, guide price, predicted price, base price, suggested price, guaranteed price, estimated price, or recommended price, is a price paid to the content publisher for either showing the advertisement (e.g., an impression), an interaction with the advertisement (e.g., a click, double click, tap, vocal command, or hand gesture corresponding to the advertisement), or another user action associated with the advertisement (e.g., a sale to the user of a product or entry by the user into a merchant store associated with the advertisement within a time period). In some embodiments, the advertiser pays the content publisher via the advertising network (e.g., the advertising network 312 of FIG. 3) that includes the mediation system 200 for one or more of the various activities associated with the advertisement. In a specific example, the advertiser may pay for an impression to the user, subsequently pay for an interaction with the advertisement by the user, and then subsequently pay for the user entering a merchant store associated with the advertisement (e.g., as determined by a GPS component of a location-enabled user device, WI-FI® triangulation of the location-enabled user device, or a communicative coupling between the location-enabled user device and a device at the merchant store such as a BLUETOOTH® beacon or similar merchant device).

In various embodiments, the price module 230 uses the context data included in the advertisement request to calculate the placement price. For example, the context data can indicate a current geolocation of the user device or an advertisement identifier associated with the advertisement request. The social module 260 can map the advertisement identifier to a member identifier of a social network service and access member data for the member identifier. In various embodiments, the price module 230 uses the member data to calculate the placement price (discussed in more detail below in connection with FIGS. 6 and 7).

In some embodiments, the price module 230 accesses information from third party servers (e.g., the third party servers 146) and uses that information to calculate the placement price. For instance, if the context data includes a current geolocation, the price module 230 may infer a user activity based on the current geolocation (e.g., if the geolocation corresponds to an airport, the price module 230 infers the user of the user device is traveling). The price module 230 may then use the inferred user activity to calculate the placement price for a particular advertisement. In another example, the price module 230 accesses weather information corresponding to the current geolocation and calculates the placement price based on the weather information (e.g., poor weather conditions may indicate a captive audience and command a higher placement price as compared to good weather conditions).

Turning now to FIG. 6, a flow diagram illustrating further example operations for calculating a price for placing an advertisement is shown. Subsequent to the content module 220 assembling the specification of the advertisement at operation 420, the price module 230 calculates the placement price for placing the advertisement at operation 430. In some embodiments, operation 430 includes the additional operations of FIG. 6.

At operation 610, the social module 260 maps an advertisement identifier included in the context data to a member identifier of a social networking service. For example, the advertisement identifier is associated with a user of the user device (e.g., the advertisement identifier can be a device identifier for a device of the user). The social module 260 maps the advertisement identifier to a member identifier by comparing the advertisement identifier to previously stored advertisement identifiers associated with members of the social network service. For example, if a particular member of the social network service logs in to the social network service from a particular device, the social module 260 stores a device identifier for the particular device in association with the particular member. Such stored device identifiers are subsequently used by the social module 260 to map an advertisement request that includes the device identifier to the particular member of the social network service. Although this example is specific to a device identifier, the social module 260 can use other types of identification associated with the user of the user device for performing mapping to the member identifier at operation 610.

At operation 620, the social module 260 accesses member data corresponding to the member identifier. For example, the member data includes demographic information (e.g., age, gender, or residence location), employment history data, current job title, number of social connections, posts, status updates, likes, favorites, and a wide variety of other data.

At operation 630, the price module 230 calculates the placement price based in part on the member data for the member identifier (see the discussion above in connection with the price module 230 of FIG. 2). For instance, the price module 230 matches a demographic characteristic of the member with a demographic characteristic specified by the advertiser and determines a higher price based on the match. That is to say, the price module 230 may calculate a similarity score between the member and an advertiser-specified profile and determine the placement price based on the similarity score (e.g., a higher score corresponds to a higher price).

In other embodiments, the price module 230 extracts various member characteristics from the member data of the member and various advertisement characteristics from the specification of the advertisement. In an example, the price module 230 compares the member characteristics with the advertisement characteristics to calculate the placement price. For example, a large number of similar, matching, or nearly match advertisement characteristics and member characteristics correspond to a higher placement price than very few matching characteristics. In some instances, the price module 230 may weight the comparison between the member characteristics and the advertisement characteristics (e.g., a particular advertisement characteristics may be a more significance and is weighted more by the price module 230 when determining the placement price). For instance, the member's preference for a particular color and the color of the advertisement may be weighted less than the member's preference for a literary content and the content of the advertisement.

Turning now to FIG. 7, a flow diagram illustrating further example operations for calculating a price for placing an advertisement using member data of a social network service is shown. Subsequent to the social module 260 accessing member data corresponding to the member identifier at operation 620, the price module 230 calculates the placement price for placing the advertising using the member data at operation 630. In some embodiments, operation 630 includes the additional operations of FIG. 7.

At operation 710, the price module 230 calculates an interaction likelihood, interaction probability, or interaction score that indicates the chance that a member of the social network service corresponding to the member identifier interacts with the advertisement. In some embodiments, the price module 230 calculates the interaction likelihood using the member data, the context data, the specification of the advertisement, or other data. For instance, the price module 230 may calculate a high interaction likelihood for a member found to be interested in a particular subject matter as indicated by the member data when the specification of the advertisement is directed to the particular subject matter.

In example embodiment, the price module 230 extracts member characteristics from the member data of the member, extracts advertisement characteristics from the specification of the advertisement, compares the extracted member characteristics with the extracted advertisement characteristics, and calculates the placement price based on the comparison (see the discussion in connection with the price module 230 of FIG. 2 above for additional detail). In a specific example, the price module 230 extracts a particular member characteristic comprising a contact member (e.g., a certain member that formed a social network relationship, such as friending or following, with the member on the social networking service) interacting with a similar advertisement. In this example, the price module 230 determines a high likelihood that the member may interact with the advertisement.

At operation 720, the price module 230 calculates the placement price for placing the advertisement according to the interaction likelihood. For instance, if the price module 230 determines a high interaction likelihood for a particular member, the price module 230 may calculate a high placement price for that particular member.

Turing again to FIG. 4, at operation 440, the transmission module 250 communicates, transmits, or otherwise provides the specification of the advertisement and the placement price to the user device. At the user device, the publisher content may include logic to utilize the placement price information to determine whether to display or present the advertisement, a competitor's advertisement, or no advertisement at all. For instance, the advertisement optimization module of the publisher content selects an advertisement corresponding to a highest placement price. In an alternative scheme (as described in connection with FIG. 3 above), the transmission module 250 may communicate the placement price or the specification of the advertisement to a publisher device that performs logic to determine whether to present the advertisement at the user device. In this way, the publisher is able to self-mediate and determine which advertisement to display based on pricing information or other information. Such transparency may encourage publishers to utilize the advertising network that provides such information and create a more efficient advertisement market.

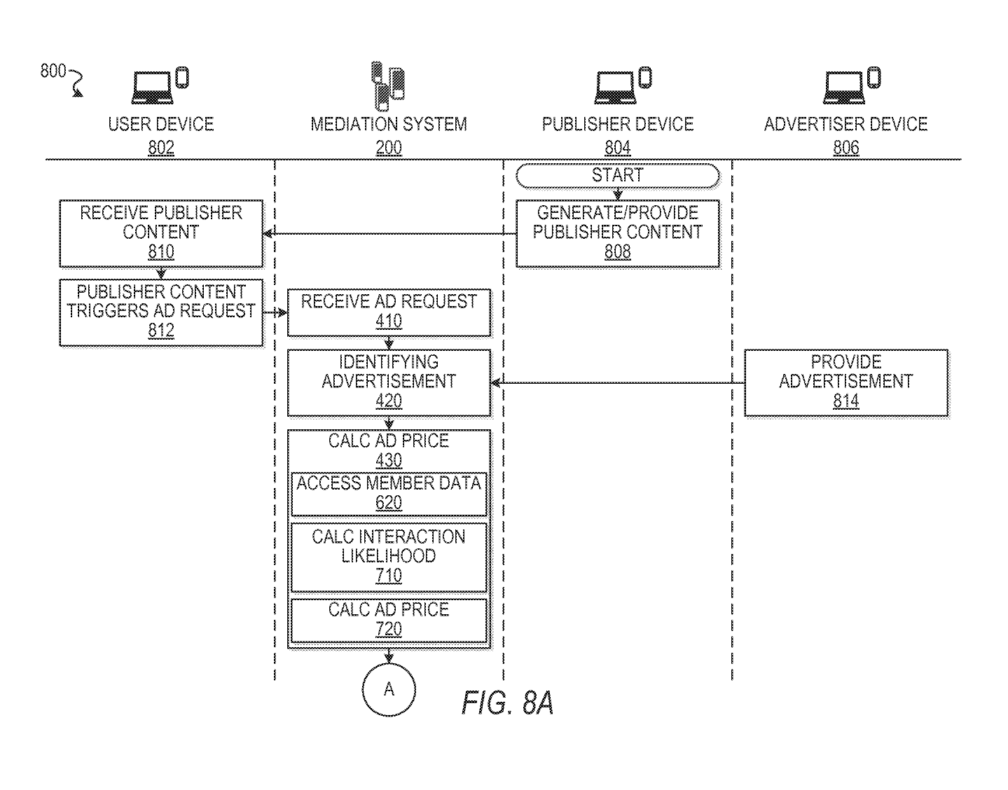

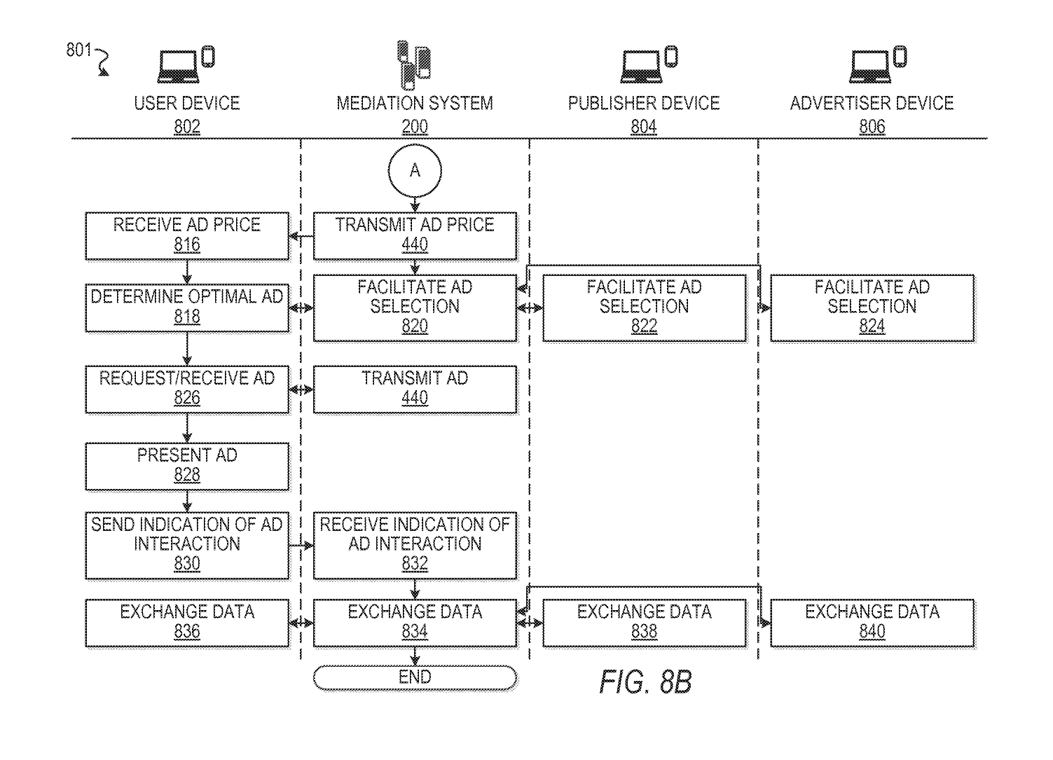

To help illustrate the concepts described above, FIGS. 8A and 8B are swim-lane diagrams 800 and 801 illustrating various communications between devices performing a method for publisher facilitated advertisement mediation, according to some example embodiments. In the diagrams 800 and 801, a user device 802, the mediation system 200, a publisher device 804, and an advertiser device 806 exchange various communications.

In FIG. 8A, at operation 808, the publisher device 804 provides or generates publisher content to be used at the user device 802. At operation 810 the user device 802 receives the publisher content. For example, the publisher content can be a website, a mobile application, or another type of digital media. At operation 812, the publisher content triggers an advertisement request. For example, the code embedded in the publisher content triggers an advertisement request upon opening a website or mobile application.

At operation 410, described above, the mediation system 200 receives the advertisement request. At operation 420, the mediation system 200 identifies an advertisement among an inventory of advertisements received from advertiser devices such as the advertiser device 806. In some embodiments, the advertiser device 806 makes a real-time bid to fill the advertisement request and, at operation 814, the advertising device 806 provides the advertisement to the mediation system 200 in real time. In other embodiments, at operation 814, the advertising device 806 provides the advertisement system to the mediation system 200 prior to the mediation system 200 receiving the advertisement request and the mediation system 200 stores the advertisement remotely or locally for subsequent access in response to a request for an advertisement.

At operation 430, the mediation system 200 calculates the placement price for the advertisement. As described above, at operation 620, the mediation system 200 may access member data, data from third party servers (e.g., the third party servers 146 of FIG. 1), or other data. At operation 710, the mediation system 200 calculates an interaction likelihood for the advertisement. At operation 720, the mediation system 200 calculates the placement price based on the interaction likelihood.

In continuing with the discussion in connection with FIG. 8A, FIG. 8B shows additional operations. At operation 440, in an embodiment, the mediation system 200 provides the placement price to the user device 802 as described above. In some embodiments, the mediation system 200 provides the placement price to the publisher device 804, although this is not shown in the diagram 801. In certain embodiments, the placement price is provided along with the specification of the advertisement. In other embodiments, the placement price, and other advisement data, are provided prior to the specification of the advertisement so that the publisher (e.g., via code embedded in the publisher content) can decide whether or not to request the advertisement. This saves the bandwidth of transmission of the specification of the advertisement if no advertisement is desired at the provided placement price.

At operation 816, the user device 802 receives the placement price. At operation 818, the publisher determines an optimal advertisement. For example, code embedded in the publisher content may specify presenting an advertisement at a highest price or an advertisement at a highest predicted price (e.g., taking into account a likelihood of the user interacting with the advertisement in a pay per click payment scheme). In some embodiments, the user device 802 communicates with the mediation system 200 at operation 820, the publisher device 804 at operation 822, the advertiser device 806 at operation 824, or a combination thereof to determine the optimal advertisement to present. For example, code embedded in the publisher content on the user device can retrieve rules or criteria specified by the publisher from the publisher device 804 or additional information regarding the advertisement from the advertiser device 806 via the mediation system 200 (e.g., demographic information regarding the advertisement).

In an embodiment, at operation 826, the user device requests the specification of the advertisement from the mediation system 200. Although, as discussed above, in other embodiments, the specification of the advertisement is provided along with the placement price. At operation 440, the mediation system 200 transmits or provides the specification of the advertisement to the user device 802.

At operation 828, the user device 802 presents the advertisement using the specification of the advertisement. For example, the user device 802 creates the advertisement using information included in the specification of the advertisement such as text and images. The created advertisement may conform to a local style of the publisher content on the user device 802 (e.g., fonts, colors, sizes, or shape of the advertisement).

In some embodiments, at operation 830, the user device 802 sends, transmits, communicates, or otherwise provides an indication of an interaction with the advertisement (e.g., a click or tap on the advertisement or the user moving within a particular geographic boundary included in the specification of the advertisement such as the boundaries of a merchant store) to the mediation system 200 in real time. At operation 832, the mediation system 200 receives the indication of the advertisement interaction. Subsequently, at operation 834, the mediation system 200 may exchange various communications with the publisher device 804 at operation 838, the advertiser device 806 at operation 840, and the user device 802 at operation 836. For instance, the mediation system 200 may provide real time updates regarding interactions or revenue generated with the advertisement. Such data can be used by the advertiser or publisher to adjust an advertising campaign by the advertiser or adjust an advertisement presentation scheme by the publisher.

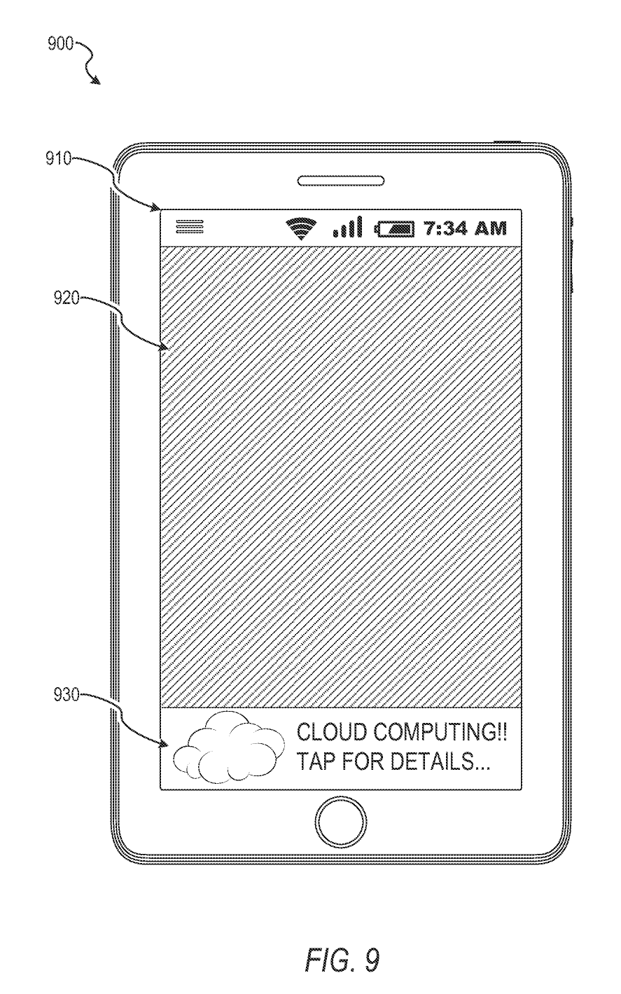

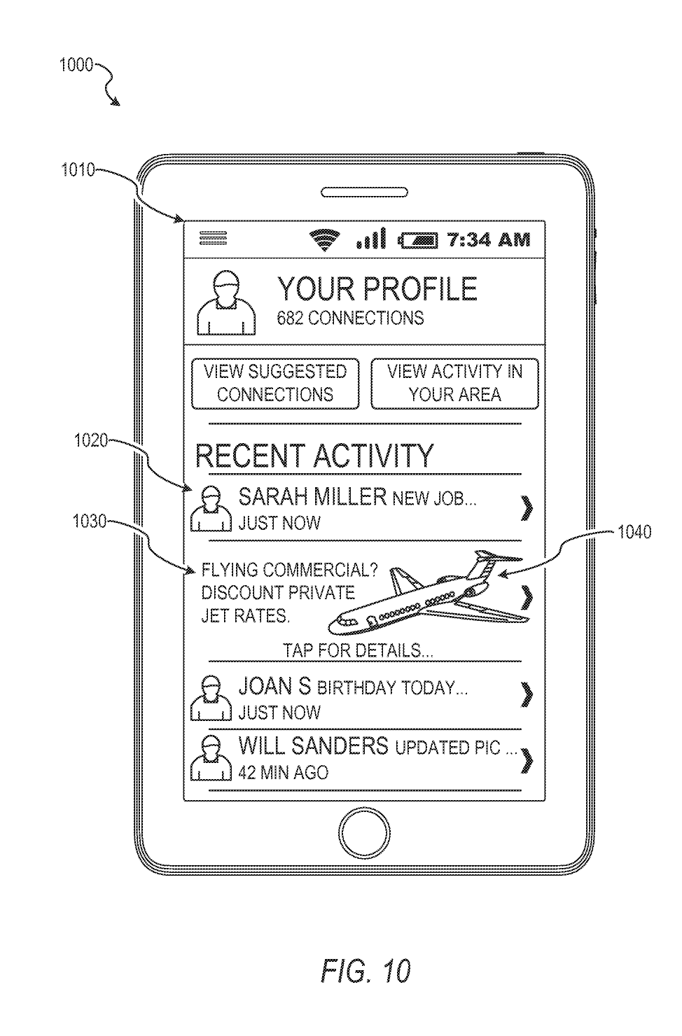

FIGS. 9 and 10 illustrate example user interfaces that include advertisements, according to some example embodiments. Although user interfaces described herein (e.g., FIGS. 9 and 10) depict specific example user interfaces and user interface elements, these are merely non-limiting examples, and many other alternate user interfaces and user interface elements can be generated by the content module 220, or are provided by the publisher as publisher content, and presented to the user. It will be noted that alternate presentations of the displays described herein include additional information, graphics, options, and so forth; other presentations include less information, or provide abridged information for easy use by the user.

FIG. 9 depicts an example user interface 910 being displayed on example device 900 (e.g., a smart phone). The user interface 910 includes publisher content 920 and an example advertisement 930. The publisher content 920 could be a website, a mobile application, or another type of media. The example advertisement 930 could be a banner advertisement or an advertisement in another form.

FIG. 10 depicts an example user interface 1010 being displayed on example device 1000. The user interface 1010 includes publisher content 1020 and an example advertisement 1030 that includes advertisement element 1040. In this example, the advertisement 1030 is generated from the specification of the advertisement that includes various advertisement elements (e.g., textual description and images of products) such as the advertisement element 1040. Here, the advertisement 1030 is integrated with the publisher content 1020 in such a way as to match stylistic elements of the publisher content 1020 and provide a better user experience. For example, the specification of the advertisement 1030 may include an image, such as the advertisement element 1040, which can be positioned and sized according to criteria specified by the publisher to conform to a particular style.

Certain embodiments are described herein as including logic or a number of components, modules, or mechanisms. Modules can constitute either software modules (e.g., code embodied on a machine-readable medium) or hardware modules. A “hardware module” is a tangible unit capable of performing certain operations and can be configured or arranged in a certain physical manner. In various example embodiments, one or more computer systems (e.g., a standalone computer system, a client computer system, or a server computer system) or one or more hardware modules of a computer system (e.g., a processor or a group of processors) can be configured by software (e.g., an application or application portion) as a hardware module that operates to perform certain operations as described herein.

In some embodiments, a hardware module can be implemented mechanically, electronically, or any suitable combination thereof. For example, a hardware module can include dedicated circuitry or logic that is permanently configured to perform certain operations. For example, a hardware module can be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module can include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) can be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module can perform an operation and store the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules can be located in a single geographic location (e.g., within a home environment, an office environment, or a server farm). In other example embodiments, the processors or processor-implemented modules are distributed across a number of geographic locations.

The modules, methods, applications and so forth described in conjunction with FIGS. 1-10 are implemented in some embodiments in the context of a machine and an associated software architecture. The sections below describe representative software architecture and machine (e.g., hardware) architecture that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, and the like. A slightly different hardware and software architecture may yield a smart device for use in the “internet of things.” While yet another combination produces a server computer for use within a cloud computing architecture. Not all combinations of such software and hardware architectures are presented here as those of skill in the art can readily understand how to implement the inventive subject matter in different contexts from the disclosure contained herein.

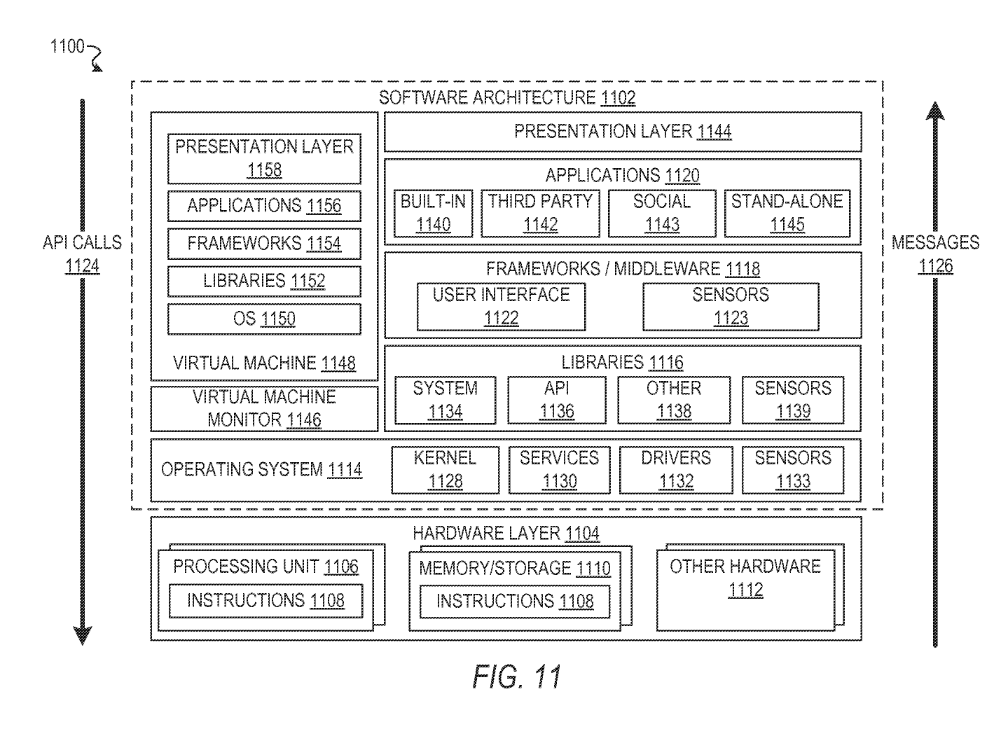

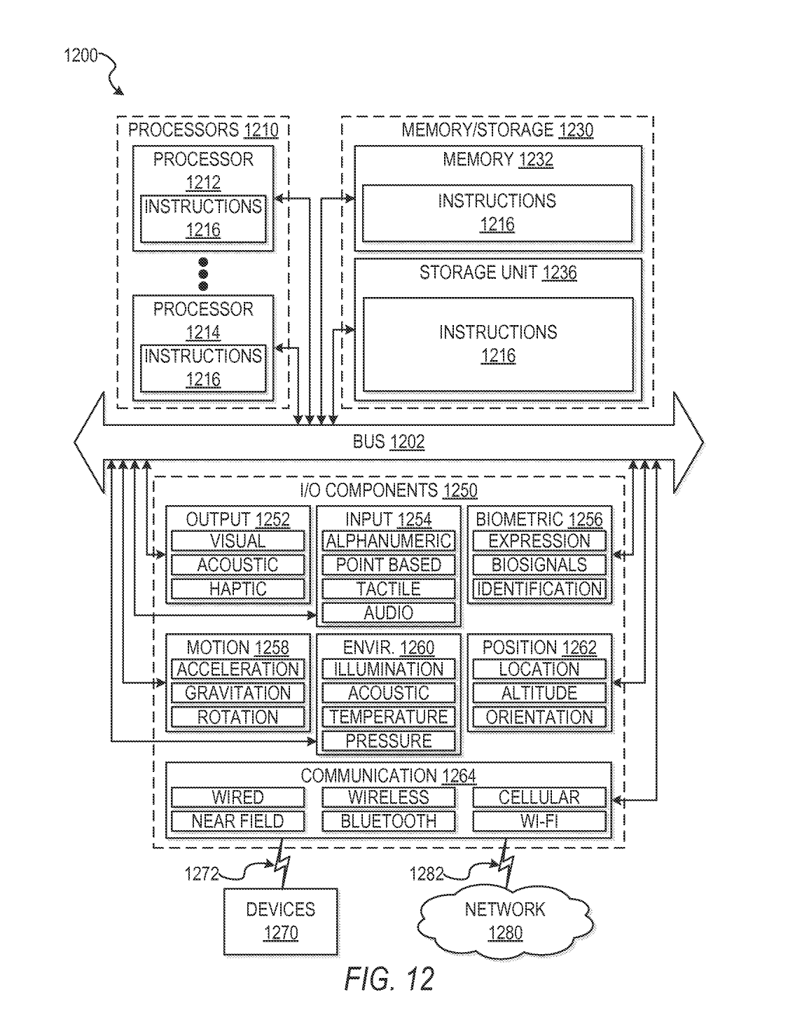

FIG. 11 is a block diagram 1100 illustrating a representative software architecture 1102, which may be used in conjunction with various hardware architectures herein described. The software architecture 1102 may be employed by the social networking 120, the user devices 302, 304, and 306, and other devices described above. FIG. 11 is merely a non-limiting example of a software architecture and it will be appreciated that many other architectures may be implemented to facilitate the functionality described herein. The software architecture 1102 may be executing on hardware such as machine 1200 of FIG. 12 that includes, among other things, processors 1210, memory/storage 1230, and I/O components 1250. A representative hardware layer 1104 is illustrated and can represent, for example, the machine 1200 of FIG. 12. The representative hardware layer 1104 comprises one or more processing units 1106 having associated executable instructions 1108. Executable instructions 1108 represent the executable instructions of the software architecture 1102, including implementation of the methods, modules and so forth of FIGS. 1-10. Hardware layer 1104 also includes memory and storage modules 1110, which also have executable instructions 1108. Hardware layer 1104 may also comprise other hardware 1112, which represents any other hardware of the hardware layer 1104, such as the other hardware illustrated as part of machine 1200.

In the example architecture of FIG. 11, the software architecture 1102 may be conceptualized as a stack of layers where each layer provides particular functionality. For example, the software architecture 1102 may include layers such as an operating system 1114, libraries 1116, frameworks/middleware 1118, applications 1120 and presentation layer 1144. Operationally, the applications 1120 or other components within the layers may invoke application programming interface (API) calls 1124 through the software stack and receive a response, returned values, and so forth illustrated as messages 1126 in response to the API calls 1124. The layers illustrated are representative in nature and not all software architectures have all layers. For example, some mobile or special purpose operating systems may not provide the frameworks/middleware 1118, while others may provide such a layer. Other software architectures may include additional or different layers.

The operating system 1114 may manage hardware resources and provide common services. The operating system 1114 may include, for example, a kernel 1128, services 1130, and drivers 1132. The kernel 1128 may act as an abstraction layer between the hardware and the other software layers. For example, the kernel 1128 may be responsible for memory management, processor management (e.g., scheduling), component management, networking, security settings, and so on. The services 1130 may provide other common services for the other software layers. The drivers 1132 may be responsible for controlling or interfacing with the underlying hardware. For instance, the drivers 1132 may include display drivers, camera drivers, BLUETOOTH® drivers, flash memory drivers, serial communication drivers (e.g., Universal Serial Bus (USB) drivers), WI-FI® drivers, audio drivers, power management drivers, and so forth depending on the hardware configuration. In an example embodiment, the operating system 1114 includes sensors 1133 that can provide various sensor input processing services such as low-level access to touchscreen input data, GPS positioning data, or other user input data.

The libraries 1116 may provide a common infrastructure that may be utilized by the applications 1120 or other components or layers. The libraries 1116 typically provide functionality that allows other software modules to perform tasks in an easier fashion than to interface directly with the underlying operating system 1114 functionality (e.g., kernel 1128, services 1130 or drivers 1132). The libraries 1116 may include system libraries 1134 (e.g., C standard library) that may provide functions such as memory allocation functions, string manipulation functions, mathematic functions, and the like. In addition, the libraries 1116 may include API libraries 1136 such as media libraries (e.g., libraries to support presentation and manipulation of various media format such as MPREG4, H.264, MP3, AAC, AMR, JPG, or PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 1116 may also include a wide variety of other libraries 1138 to provide many other APIs to the applications 1120 and other software components/modules. In an example embodiment, the libraries 1116 include sensor libraries 1139 that provide input tracking, GPS updating and tracking, capture, or otherwise monitor user input and device sensor input such as touchscreen input that can be utilized by the mediation system 200.

The frameworks/middleware 1118 (also sometimes referred to as middleware) may provide a higher-level common infrastructure that may be utilized by the applications 1120 or other software components/modules. For example, the frameworks/middleware 1118 may provide various graphic user interface (GUI) functions, high-level resource management, high-level location services, and so forth. The frameworks/middleware 1118 may provide a broad spectrum of other APIs that may be utilized by the applications 1120 or other software components/modules, some of which may be specific to a particular operating system or platform. In an example embodiment, the frameworks/middleware 1118 include a user interface framework 1122 and a sensors framework 1123. The user interface framework 1122 can provide high-level support for touch input functions that can be used in aspects of the mediation system 200. Similarly, the sensor framework 1123 can provide high-level support for sensor input and other user input detection.

The applications 1120 include built-in applications 1140 or third party applications 142. Examples of representative built-in applications 1140 may include, but are not limited to, a contacts application, a browser application, a book reader application, a location application, a media application, a messaging application, or a game application. Third party applications 1142 may include any of the built-in applications as well as a broad assortment of other applications. In a specific example, the third party application 1142 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or other mobile operating systems. In this example, the third party application 1142 may invoke the API calls 1124 provided by the mobile operating system such as operating system 1114 to facilitate functionality described herein. In an example embodiment, the applications 1120 include a social application 1143 that includes the mediation system 200, or a portion thereof, as part of the application. In another example embodiment, the applications 1120 include a stand-alone application 1145 that includes the mediation system 200, or a portion thereof.

The applications 1120 may utilize built-in operating system functions (e.g., kernel 1128, services 1130 or drivers 1132), libraries (e.g., system libraries 1134, API libraries 1136, and other libraries 1138), frameworks/middleware 1118 to create user interfaces to interact with users of the system. Alternatively, or additionally, in some systems interactions with a user may occur through a presentation layer, such as presentation layer 1144. In these systems, the application/module “logic” can be separated from the aspects of the application/module that interact with a user.

Some software architectures utilize virtual machines. In the example of FIG. 11, this is illustrated by virtual machine 1148. A virtual machine creates a software environment where applications/modules can execute as if they were executing on a hardware machine (such as the machine 1200 of FIG. 12, for example). The virtual machine 1148 is hosted by a host operating system (operating system 1114 in FIG. 12) and typically, although not always, has a virtual machine monitor 1146, which manages the operation of the virtual machine 1148 as well as the interface with the host operating system (i.e., operating system 1114). A software architecture executes within the virtual machine 1148 such as an operating system 1150, libraries 1152, frameworks/middleware 1154, applications 1156 or presentation layer 1158. These layers of software architecture executing within the virtual machine 1148 can be the same as corresponding layers previously described or may be different.

FIG. 12 is a block diagram illustrating components of a machine 1200, according to some example embodiments, able to read instructions from a machine-readable medium (e.g., a machine-readable storage medium) and perform any one or more of the methodologies discussed herein. Specifically. FIG. 12 shows a diagrammatic representation of the machine 1200 in the example form of a computer system, within which instructions 1216 (e.g., software, a program, an application, an applet, an app, or other executable code) for causing the machine 1200 to perform any one or more of the methodologies discussed herein can be executed. For example, the instructions 1216 can cause the machine 1200 to execute the flow diagrams of FIG. 4, 5, 6, 7, 8A, or 8B. Additionally, or alternatively, the instruction 1216 can implement the aggregation module 210, the content module 220, the price module 230, the submission module 240, the transmission module 250, or the social module 260 of FIG. 2, and so forth. The instructions 1216 transform the general, non-programmed machine into a particular machine programmed to carry out the described and illustrated functions in the manner described. In alternative embodiments, the machine 1200 operates as a standalone device or can be coupled (e.g., networked) to other machines. In a networked deployment, the machine 1200 may operate in the capacity of a server machine or a client machine in a server-client network environment, or as a peer machine in a peer-to-peer (or distributed) network environment. The machine 1200 can comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1216, sequentially or otherwise, that specify actions to be taken by the machine 1200. Further, while only a single machine 1200 is illustrated, the term “machine” shall also be taken to include a collection of machines 1200 that individually or jointly execute the instructions 1216 to perform any one or more of the methodologies discussed herein.

The machine 1200 can include processors 1210, memory/storage 1230, and I/O components 1250, which can be configured to communicate with each other such as via a bus 1202. In an example embodiment, the processors 1210 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) can include, for example, processor 1212 and processor 1214 that may execute instructions 1216. The term “processor” is intended to include multi-core processor that may comprise two or more independent processors (sometimes referred to as “cores”) that can execute instructions contemporaneously. Although FIG. 12 shows multiple processors 1210, the machine 1200 may include a single processor with a single core, a single processor with multiple cores (e.g., a multi-core processor), multiple processors with a single core, multiple processors with multiples cores, or any combination thereof.

The memory/storage 1230 can include a memory 1232, such as a main memory, or other memory storage, and a storage unit 1236, both accessible to the processors 1210 such as via the bus 1202. The storage unit 1236 and memory 1232 store the instructions 1216 embodying any one or more of the methodologies or functions described herein. The instructions 1216 can also reside, completely or partially, within the memory 1232, within the storage unit 1236, within at least one of the processors 1210 (e.g., within the processor's cache memory), or any suitable combination thereof, during execution thereof by the machine 1200. Accordingly, the memory 1232, the storage unit 1236, and the memory of the processors 1210 are examples of machine-readable media.

As used herein, the term “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) or any suitable combination thereof. The term “machine-readable medium” should be taken to include a single medium or multiple media (e.g., a centralized or distributed database, or associated caches and servers) able to store instructions 1216. The term “machine-readable medium” shall also be taken to include any medium, or combination of multiple media, that is capable of storing instructions (e.g., instructions 1216) for execution by a machine (e.g., machine 1200), such that the instructions, when executed by one or more processors of the machine 1200 (e.g., processors 1210), cause the machine 1200 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1250 can include a wide variety of components to receive input, provide output, produce output, transmit information, exchange information, capture measurements, and so on. The specific I/O components 1250 that are included in a particular machine will depend on the type of machine. For example, portable machines such as mobile phones will likely include a touch input device or other such input mechanisms, while a headless server machine will likely not include such a touch input device. It will be appreciated that the I/O components 1250 can include many other components that are not shown in FIG. 12. The I/O components 1250 are grouped according to functionality merely for simplifying the following discussion, and the grouping is in no way limiting. In various example embodiments, the I/O components 1250 can include output components 1252 and input components 1254. The output components 1252 can include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1254 can include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

In further example embodiments, the I/O components 1250 can include biometric components 1256, motion components 1258, environmental components 1260, or position components 1262 among a wide array of other components. For example, the biometric components 1256 can include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1258 can include acceleration sensor components (e.g., an accelerometer), gravitation sensor components, rotation sensor components (e.g., a gyroscope), and so forth. The environmental components 1260 can include, for example, illumination sensor components (e.g., a photometer), temperature sensor components (e.g., one or more thermometers that detect ambient temperature), humidity sensor components, pressure sensor components (e.g., a barometer), acoustic sensor components (e.g., one or more microphones that detect background noise), proximity sensor components (e.g., infrared sensors that detect nearby objects), gas sensor components (e.g., machine olfaction detection sensors, gas detection sensors to detect concentrations of hazardous gases for safety or to measure pollutants in the atmosphere), or other components that may provide indications, measurements, or signals corresponding to a surrounding physical environment. The position components 1262 can include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication can be implemented using a wide variety of technologies. The I/O components 1250 may include communication components 1264 operable to couple the machine 1200 to a network 1280 or devices 1270 via a coupling 1282 and a coupling 1272, respectively. For example, the communication components 1264 include a network interface component or other suitable device to interface with the network 1280. In further examples, communication components 1264 include wired communication components, wireless communication components, cellular communication components, Near Field Communication (NFC) components, BLUETOOTH® components (e.g., BLUETOOTH® Low Energy), WI-FI® components, and other communication components to provide communication via other modalities. The devices 1270 may be another machine or any of a wide variety of peripheral devices (e.g., a peripheral device coupled via a Universal Serial Bus (USB)).

Moreover, the communication components 1264 can detect identifiers or include components operable to detect identifiers. For example, the communication components 1264 can include Radio Frequency Identification (RFID) tag reader components, NFC smart tag detection components, optical reader components (e.g., an optical sensor to detect one-dimensional bar codes such as a Universal Product Code (UPC) bar code, multi-dimensional bar codes such as a Quick Response (QR) code, Aztec Code, Data Matrix, Dataglyph, MaxiCode, PDF417, Ultra Code, Uniform Commercial Code Reduced Space Symbology (UCC RSS)-2D bar codes, and other optical codes), acoustic detection components (e.g., microphones to identify tagged audio signals), or any suitable combination thereof. In addition, a variety of information can be derived via the communication components 1264, such as location via Internet Protocol (IP) geo-location, location via WI-FI® signal triangulation, location via detecting a BLUETOOTH® or NFC beacon signal that may indicate a particular location, and so forth.

In various example embodiments, one or more portions of the network 1280 can be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a WI-FI® network, another type of network, or a combination of two or more such networks. For example, the network 1280 or a portion of the network 1280 may include a wireless or cellular network, and the coupling 1282 may be a Code Division Multiple Access (CDMA) connection, a Global System for Mobile communications (GSM) connection, or other type of cellular or wireless coupling. In this example, the coupling 1282 can implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 1216 can be transmitted or received over the network 1280 using a transmission medium via a network interface device (e.g., a network interface component included in the communication components 1264) and utilizing any one of a number of well-known transfer protocols (e.g., Hypertext Transfer Protocol (HTTP)). Similarly, the instructions 1216 can be transmitted or received using a transmission medium via the coupling 1272 (e.g., a peer-to-peer coupling) to devices 1270. The term “transmission medium” shall be taken to include any intangible medium that is capable of storing, encoding, or carrying the instructions 1216 for execution by the machine 1200, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A system comprising:
a computer-readable medium having instructions stored thereon, which, when executed by a processor, cause the system to:
receive, from a user system, a fill request to fill a vacant advertisement position on a user interface of the user system, the fill request including context data indicating a context of the fill request;
in response to the fill request, generate advertisement data to be used at the user system to create an advertisement;
calculate a content specific price for positioning the advertisement on the user interface of the user system based on the context data; and
communicate the advertisement data and the content specific price to the user system.

2. The system of claim 1, wherein the system is further to:
map an advertisement identifier included in the context data to a member identifier of a social networking service;
access, from the social networking service, member data that corresponds to the member identifier, and
calculate the content specific price based in part on the member data for the member identifier.

3. The system of claim 2, wherein the calculating the content specific price based in part on the member data further comprises:
calculating an interaction likelihood that a member of the social network service corresponding to the member identifier interacts with the advertisement, the interaction likelihood being calculated based on the context data and the member data; and
calculating the content specific price according to the interaction likelihood.

4. The system of claim 1, wherein the system is further to:
access a plurality of advertisements submitted by at least one advertiser; and
identify a particular advertisement among the plurality of advertisements and generate the advertisement data from the particular advertisement to provide in response to the fill request.

5. The system of claim 4, wherein the system is further to:
access a bid price for respective advertisements of the plurality of advertisements, the bid price indicates a price that the advertiser pays for at least one of a user interaction with the advertisement or a user view of the advertisement; and
identify the particular advertisement according to a highest bid price for the respective advertisements of the plurality of advertisements.

6. A method comprising:
receiving, from a user device, an advertisement request for advertisement content, the advertisement request including context data indicating a context of the advertisement request;
in response to the advertisement request, assembling a specification of an advertisement to be used at the user device to create the advertisement;
calculating, using a processor of a machine, a placement price for placing the advertisement on a user interface of the user device based on the context data; and
transmitting the specification of the advertisement and the placement price to the user device.

7. The method of claim 6, further comprising:
mapping an advertisement identifier included in the context data to a member identifier of a social networking service;
accessing, from the social networking service, member data corresponding to the member identifier; and
calculating the placement price based in part on the member data for the member identifier.

8. The method of claim 7, wherein calculating the placement price based in part on the member data further comprises:
calculating an interaction likelihood that a member of the social network service corresponding to the member identifier interacts with the advertisement, the interaction likelihood being calculated based on the context data and the member data; and
calculating the placement price according to the interaction likelihood.

9. The method of claim 6, further comprising:
accessing an inventory of advertisements submitted by at least one advertiser, and
identifying a particular advertisement among the inventory of advertisements to provide in response to the advertisement request.

10. The method of claim 9, further comprising:
accessing a bid price for respective advertisements of the inventory of advertisements, the bid price indicates a price that the advertiser pays for at least one of a user interaction with the advertisement or a user view of the advertisement; and
identifying the particular advertisement according to a highest bid price for the respective advertisements of the inventory of advertisements.

11. The method of claim 6, wherein the specification of the advertisement includes customizable portions of the advertisement customizable at the user device.

12. The method of claim 11, wherein the customizable portions of the advertisement comprise at least one of a title, an email, or a background image.

13. The method of claim 6, wherein the context data includes sensor data detected at the user device, wherein the sensor data includes geolocation data indicating a current geolocation of the user device.

14. A machine-readable medium having no transitory signals and storing instructions that, when executed by at least one processor of a machine, cause the machine to perform operations comprising:
receiving, from a user device, a placement request to receive marketing content for an advertisement space on a user interface of the user device, the placement request including context data indicating a context of the placement request;
in response to the placement request, generating advertisement metadata to be used at the user device to create an advertisement;
calculating a probable price for placing the advertisement on the user interface of the user device based on the context data; and
providing the advertisement metadata and the probable price to the user device.

15. The machine-readable medium of claim 14, wherein the operations further comprise:
mapping an advertisement identifier included in the context data to a member identifier of a social networking service;
accessing, from the social networking service, member data corresponding to the member identifier; and
calculating the probable price based in part on the member data for the member identifier.

16. The machine-readable medium of claim 14, wherein the operations further comprise:
accessing an inventory of advertisements submitted by at least one advertiser, and
identifying a particular advertisement among the inventory of advertisements to provide in response to the placement request.

17. The machine-readable medium of claim 16, further comprising:
accessing a bid price for respective advertisements of the inventory of advertisements, the bid price indicates a price that the advertiser pays for at least one of a user interaction with the advertisement or a user view of the advertisement; and
identifying the particular advertisement according to a highest bid price for the respective advertisements of the inventory of advertisements.

18. The machine-readable medium of claim 14, wherein the advertisement metadata includes customizable portions of the advertisement customizable at the user device.

19. The machine-readable medium of claim 18, wherein the customizable portions of the advertisement comprise at least one of a title, an email, or a background image.

20. The machine-readable medium of claim 14, wherein the context data includes sensor data detected at the user device, wherein the sensor data includes geolocation data indicating a current geolocation of the user device.
